(19) United States
(12) Patent Application Publication
(10) Pub. No.: US 2025/0130962 A1
(43) Pub. Date: Apr. 24, 2025

(54) Peer-to-Peer Interfaced Supplemental Computing Nodes

(71) Applicant: Marvell Asia Pte Ltd, Singapore (SG)

(72) Inventor: Avi Haimzon, Ness Ziona (IL)

(21) Appl. No.: 18/680,419

(22) Filed: May 31, 2024

Related U.S. Application Data
(60) Provisional application No. 63/544,941, filed on Oct. 19, 2023.

(51) Int. Cl. G06F 13/20; G06F 13/42

(52) U.S. Cl. CPC G06F 13/20; G06F 13/4221; G06F 2213/0026

(57) ABSTRACT

New and advanced computing tools and operations require increasingly large amounts of memory and computing power. Disclosed herein are novel apparatus and methods the provide a scalable, modular, and adaptable design that enables any desired configured of additional nodes to be connected to and used to host computing nodes. The design does not require changes to the hardware, software, or protocols of the host computing nodes which can view the additional nodes as a unitary source of supplemental compute and memory. The disclosed design includes the connection of additional nodes in a peer-to-peer topology that enables a chain interconnected of multiple additional nodes share a single connection to a host node. This avoids the limitations imposed by individual node space and configurations on the amount of compute and memory that can be provided to host nodes.

### RELATED APPLICATION

This application claims the benefit of U.S. Provisional Application No. 63/544,941, filed on Oct. 19, 2023. The entire teachings of the above application are incorporated herein by reference.

### BACKGROUND

Developments in modern computing and server design, including but not limited to the incorporation and use of generative artificial intelligence (AI), have greatly increased the demand for both memory and computing power (referred to herein as “compute”). For example, machine learning models often require large amounts of computing power to execute, train, and use large training sets that need to be stored in easily accessible memory. Unitary chip designs have been unable to keep pace with this increasing need for more memory and computing power.

One possible method of satisfying the increased need for more memory and compute is to utilize more primary (“host”) computing nodes or chips, but this can become expensive and inefficient. Because of these limitations, an evolution has begun in system and chip design that incorporates off-chip and/or external memory and computing power, such as memory expanders and near memory computes (NMCs) that can be connected to and subsequently utilized by primary host computing nodes. A need exists for improvements on how to incorporate additional memory and computing power that does not require alternation of the primary host(s) and can be tailored to a specific system's memory and computing power needs.

### SUMMARY

A novel design is provided that includes an external, off-chip, or off server apparatus that can supply sufficient compute and data storage capabilities to satisfy the increasing demand for computing power and/or memory. This design incorporates peer-to-peer connections between non-host nodes, for non-liming example in a daisy chain topology, and enables linear compute and memory scalability, very high memory capacity, and very high computing power. Furthermore, this novel design can be modular and tailored to a specific system's or host computing node(s)' exact memory and compute needs without requiring, at either the hardware or software level, alternations to the host computing nodes.

Certain embodiments of the invention include an apparatus comprising an I/O interface configured to receive at least one operation and a set of nodes configured to perform the received at least one operation. Each node of the set of nodes comprising at least one peer-to-peer interface configured to connect to another node of the set of nodes and communicate the received at least one operation and local memory configured to store data.

At least one node of the set of nodes can be a memory expander configured to provide additional memory for performing the received at least one operation or a near memory compute (NMC) configured to provide additional compute power for performing the received at least one operation,

The set of nodes can be further configured to execute the received at least one operation in parallel or jointly. In some embodiments, the at least one operation originates from at least one external host. In such embodiments, the at least one external host may utilize the set of nodes as a unitary entity.

One or both of the I/O interface and the at least one peer-to-peer interfaces can be PCI Express (PCIe) interfaces and the PCI Express (PCIe) interfaces may utilize Computer Express Link (CXL) protocol. The set of nodes can be configured to be modular and a number and a type of nodes comprising the set of nodes may be variable.

The I/O interface can be configured to couple the set of nodes to at least one host computing node and in such embodiments, the at least one computing node can be located on a different chip than the set of nodes.

The peer-to-peer interfaces of the nodes comprising the set of nodes can be configured to removably couple the set of nodes.

Additional embodiments of the invention include a method for performing computing operations, the method comprising receiving, by an I/O interface, at least on one operation and performing, by a set of nodes, the received at least one operation. Each node of the set of nodes comprising at least one peer-to-peer interface configured to connect to another node of the set of nodes and communicate the received at least one operation and local memory configured to store data.

In such a method, the at least one node of the set of nodes can be a memory expander configured to provide additional memory for performing the received at least one operation or a near memory compute (NMC) configured to provide additional compute power for performing the received at least one operation. The set of nodes can be connected by the peer-to-peer interfaces in a daisy chain topology.

In select embodiments, the method further comprising sending, from a host computing node, the least on one operation. In such embodiments, the host computing node can be located on a server external to the set of nodes. Also in such embodiments, the method may further comprise removably coupling the set of nodes to the host computing node utilizing the I/O interface and the host computing node may utilize the set of nodes as a unitary entity.

The method can further include modulating the number or a type of nodes comprising the set of nodes based upon the requirements of the received at least on one operation.

Further embodiments of the invention include an apparatus for performing computing operations, the apparatus comprising means for receiving at least one operation and means for performing, by a set of nodes, the received at least one operation configured, each node of the set of nodes comprising means for connecting to another node of the set of nodes and communicating the received at least one operation. In such embodiments, at least one node of the set of nodes can be a memory expander comprising means for providing additional memory for performing the received at least one operation or a near memory compute (NMC) comprising means for providing additional compute power for performing the received at least one operation.

The apparatus may also include means for removably coupling to a source of the at least one operation. The source of the at least one operation can utilize the set of nodes as a unitary entity.

The apparatus can also include comprising means for modulating the number or a type of nodes comprising the set of nodes based upon the requirements of the received at least on one operation.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is an illustration of a set of computing host nodes embodying the prior art.

FIG. 1B is block diagram of a set of host nodes connected to a near memory compute node embodying the prior art.

FIG. 2A is an illustration of a set of host nodes connected to a chain of additional nodes of an example embodiment of the invention.

FIG. 2B is s block diagram of a set of host nodes connected to additional nodes of an example embodiment of the invention.

FIG. 3A is a block diagram of a set of host nodes connected to a near memory compute or a memory expander embodying the prior art.

FIG. 3B are block diagrams of alternative systems of a set of host nodes connected to near memory computes, memory expanders, or both of example embodiments of the invention.

FIG. 4 is a diagram of a chip that includes a set of additional nodes capable of connecting to host nodes of an example embodiment of the invention.

### DETAILED DESCRIPTION

A description of example embodiments follows.

The teachings of all patents, published applications, and references cited herein are incorporated by reference in their entirety.

Current computer (as used herein “computer” includes any apparatus or device capable of reading and executing digital instructions) and server architecture is based on the combination of graphics processing unit(s) (GPU) and central processing unit(s) (CPU) that provided computing power (“compute”) to perform task or operations. The combination of a GPU-CPU comprises a compute or computing node. The compute node interfaces with memory, such as dynamic random access memory (DRAM) or other data storage devices or components, and during the performance of tasks or operations can read data into and/or write data out of the memory. The compute, provided by the compute node, uses connected memory, provided by DRAM, data storage devices, or other data storage components, to perform received operations, tasks, and instructions. These operations, tasks, and instructions can originate from and/or be executed in response to received inputs, software programs, or result from the performance of any other function of computing devices.

Traditionally, memory is provided by components directly incorporated on the same apparatus, chip, or device that also included the compute node. Memory integrated this way is referred to as local memory such as Local DRAM. Due to space and power limitations, this unitary design is only able to include the amount of memory and compute that can be provided by components that fit on a single device or chip. Furthermore, the amount of memory and compute on a single device or chip may be set during manufacture or limited by a fixed number of component connections or port configuration, limiting flexibility and adaptability. Because of their limitations, single chip designs have difficulty satisfying the increasing demand for memory and compute required by complex computer operations. Some developments in computer architecture and design, such as non-uniform memory access (NUMA) memory design have attempted to increase the capacity of local memory and compute, but they still fall short of ever-increasing memory and compute requirements, especially those driven by the adaption of generative AI and machine learning.

Due to the limitation of unitary or single chip designs, designs that utilized multiple connected chips, devices, components, or nodes have been developed. It is possible to increase a system's compute and memory by adding more compute nodes however, that also increases the power, cost, and complexity of the system. However, in embodiments of the invention it is not required to add a complete compute node with its own GPU, CPU, and memory but instead add nodes configured to provide only the particular functions or resources required by the system. For example, if more memory is needed a memory expander node can be used that provides additional data storage space without any corresponding computing power, avoiding the addition of unnecessary computing components. Alternatively, if more compute is needed, a near memory compute (NMC) node can be utilized that provides additional computing power, for example by including additional CPUs, that are capable of processing data stored on memory local to the NMC or on a connected node but may not include other components such as GPUs as it does not require full compute node functionality. These additional dedicated nodes (referred to herein as “additional nodes”) can be connected to, and their resources utilized by, a computing node (referred to herein as a “host node” or “host computing node”). This connection may be made using a computer express link (CXL) built on a PCI Express (PCIe) or an equivalent interface with sufficient bandwidth enable high speed operations and functions. However, in existing system designs, the ability to connect additional nodes such as memory expanders and NMCs, to host computing nodes is limited by their ability to directly connect to the interfaces or ports of the host computing node(s). For example, a host computing node with only three external input/output ports or interfaces, such as PCIe ports, will only be able to connect with and utilize three additional nodes or possibly less if some of those ports or interfaces were used to connect to other host computing nodes or devices. Furthermore, a host computing node would have to manage communication to its connected additional node separately increasing the complexity of task management and data fidelity operations. Some prior art designs also incorporate additional nodes on the same chip, board, or apparatus that includes the host computing node which results in the capacity to add additional nodes (and the resources they provide) being limited by the space provided by and structure of that shared chip, board, or apparatus.

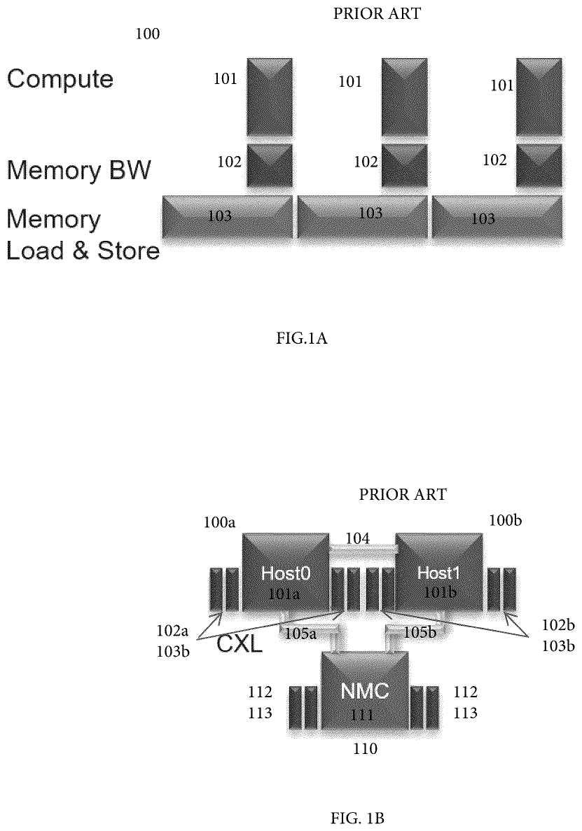

FIG. 1A is an illustration of a set of computing host nodes 100 embodying the prior art. FIG. 1A shows a set of three host nodes 100, each comprised of a compute 101, memory bandwidth 102, and memory load and store 103. The set of host nodes 100 receive, originate, and/or execute computer operatable tasks and instructions. The compute 101, for example a CPU-GPU combination or other similar computing components that can execute or perform computer operatable tasks and instructions, provides the computing power. Each compute 101, utilizes memory bandwidth 102 to store, read, and/or write data into and out of memory load and store 103. Memory load and store 103 may be local memory on the same chip/device of compute 101 such as but not limited to DRAM. If host nodes 100 are connected, computes 101 may utilize the memory bandwidth 102 and memory load and store 103 associated with other computes 101 or located on other host nodes. Each computing node of the set of computing nodes 100 is its own complete computing device and while they can function as supplemental sources of memory, provided by memory bandwidth 102 and memory load and store 103, and compute 101, provided by computing components such as CPUs and GPUs, continuing to connect complete computing nodes to set 100 to meet increasing memory and compute requirements can become prohibitively expensive and complex.

FIG. 1B is a block diagram of a set of host nodes 100a, 100b connected to a near memory compute node 110 embodying the prior art. To address the compute and memory limitations of computing nodes 100a, 100b, some prior art designs connect them to an additional node, such as near memory compute (NMC) node 110. Additional node 110, does not need to have all the components of a full computing node and therefore provides a less resource intensive way to add additional compute or memory to the system when compared to adding further complete computing nodes 100a, 100b. In such a configuration, computing nodes 100a, 100b are referred to as hosts, host nodes, or host computing nodes. Computing nodes 100a, 100b retain their compute components 101a, 101b and memory components 102a, 102b, 103a, 103b shown in and described in relation to FIG. 1A. Computing nodes 100a, 100b can be connected using interface 104 which allows them to utilize the other nodes components for shared or parallel operations. Interface 104 may be a PCIe port that utilizes CXL or other similar interfaces, devices, or connections capable enabling of host-host communication. Host computing nodes 100a, 100b may be connected using interfaces 105a, 105b to an additional node, such as near memory compute (NMC) node 110, capable of providing additional memory, additional compute, or both. Interfaces 105a, 105b may be PCIe ports that utilizes CXL or other similar interfaces capable of host-node communication. However, in such prior art designs, even though additional node 110 is separate from host computing nodes 100a, 100b it is often integrated into a unitary, server, device or board and cannot be easily removed, supplemented, or modified. Furthermore, the amount of supplemental memory or compute able to added is constrained by the space and configuration limitations of the additional node 110.

Additional node 110 can provide additional compute using its own computing components 111 such as CPUs, GPUs, or other similar components, and may provide additional memory using its own memory bandwidth 112 and memory load and store 113 and/or other similar memory components. This additional compute and/or memory can be accessed and used by host computing nodes 100a, 100b through interfaces 105a, 105b and enable parallel operations. The additional node 110 may further include hardware or software capable of providing errant protection to ensure data fidelity with host computing nodes 100a, 100b. If the additional node is a NMC, it may store data locally on its memory components 112, 113 and use its computing components 111 to perform local operations based upon communications it receives from host computing nodes 100a, 100b. Data stored on memory components 112, 113 of additional node 110 may be copied from memory components 102a, 102b, 103a, 103b of host computing nodes 100a, 100b. If the additional node is a memory expander, host computing nodes 100a, 100b and their computing components 101a, 101b may access and utilize data stored on its memory components 112, 113 directly without any local computing operations occurring on node 110. However, because in prior art embodiment additional node 110 is connected directly to host computing nodes 100a, 100b the number of additional nodes 110, and any compute or memory provided by node components 111, 112, 113, that can be added to the system is limited by the number of interfaces 115a, 115b available.

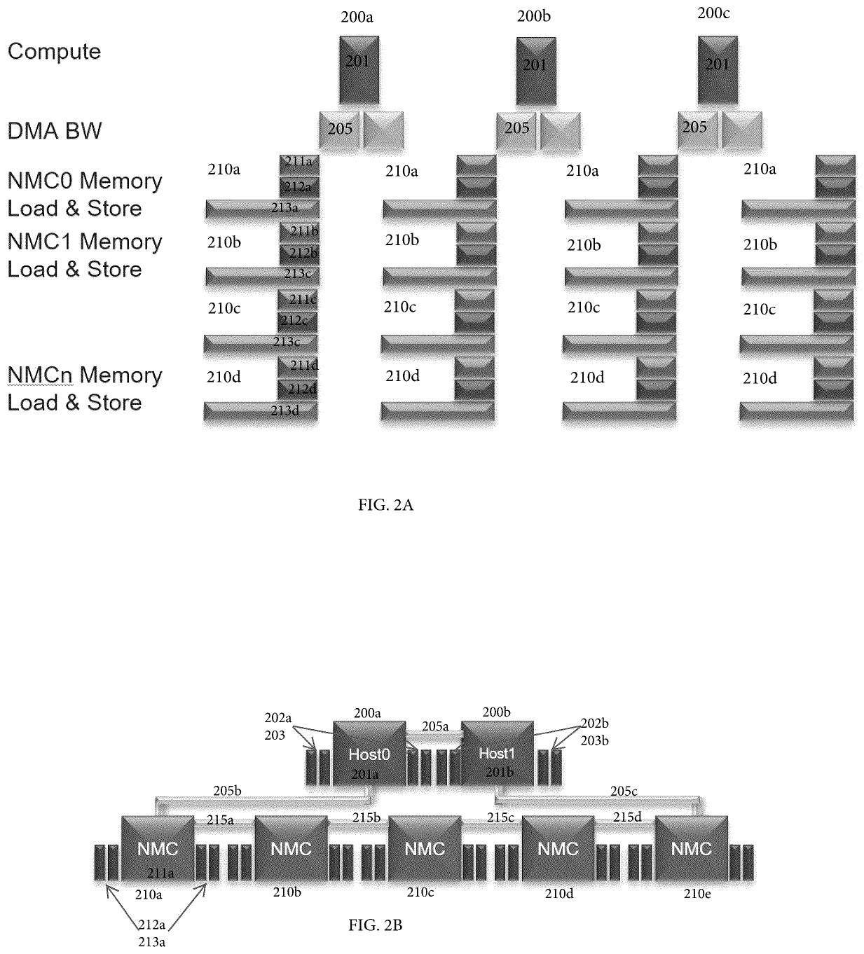

FIG. 2A is an illustration of a set of host nodes 200a, 200b, 200c connected to a chain of additional nodes 210a, 210b, 210c, 210d of an example embodiment of the invention. To solve the limitations of the prior art, disclosed herein is a design that that comprises multiple additional nodes 210a-d connected in a peer-to-peer daisy chain topology and enables linear compute and memory scalability while only requiring a single connection to hosts nodes 200a, 200b, 200c. Other connection topologies in addition to or instead of daisy chain topology may be used to connect additional nodes 210a-d in a peer-to-peer configuration. Additional nodes 210a-d can be NMCs (for increasing compute power) or memory expanders (for increasing data storage and memory) and are connected peer-to-peer to each other forming a chain. That chain of additional nodes 210a-d can then be connected by the additional node at the end of the chain 210a, using a shared input output interface, to host computing nodes 200a-c. Because a shared input output interface can connect (directly or indirectly through host to host connection such as interface 104) to all additional nodes 210a-d, the host compute nodes 200a-c can view and treat the chain of additional nodes 210a-d as a single additional node and utilize the compute and memory they provide in a manner similar to the prior art design shown in in the FIG. 1B. This enables, the disclosed novel design to be incorporated by existing host computing nodes without significant hardware, software, or communications protocol changes. However in contrast to prior art designs, the chain of nodes 210a-d is scalable, through the unbounded connection of more additional nodes, and can provide far more compute power or memory than the single additional node 110 can provide.

FIG. 2A shows a set of three host nodes 200a, 200b, 200c that include their own respective computing components 201 and memory components (not shown). Each host node 200a, 200b, 200c includes interface 205 that can be capable of functioning as direct memory access (DMA) and facilitate the transfer and communication of data, requests, and operations between host nodes 200a, 200b, 200c. Host nodes 200a, 200b, 200c may use interfaces 205 to connect to each other to share compute and memory between them. Additional nodes 210a-d are connected to each other in a daisy chain topology through peer-to-peer interfaces or ports. Specifically, additional node 210a is connected to additional node 210b, which is connected to additional node 210c, which is connected to additional node 210d. Any number of additional nodes can be included in the chain and, because of the sequential manner of connection, the additional nodes 210a-d only require two peer-to-peer interfaces regardless of the number of connected nodes. The peer-to-peer interfaces of additional nodes 210a-d enable the communication and transport of requests, and operations between the additional nodes 210a-d similar to how interfaces 205 permit communication of requests, and operations between host nodes 200a, 200b, 200c. The requests and operations may originate from host nodes 200a, 200b, 200c, additional nodes 210a-d, or external devices and make use of the compute provided by computing components 201, 211a-d and/or the memory provided by memory components 211a-d, 212a-d of additional nodes 210a-d or the memory components host nodes 200a, 200b, 200c. Data may be copied and transferred between memory components 211a-d, 212a-d of additional nodes 210a-d and the memory components host nodes 200a, 200b, 200c as required and host notes 201 and additional nodes 210a-d may preform data fidelity operations to ensure data is not corrupted or erroneously edited. The requests and operations may be performed in parallel or jointly by any combination of hosts 200a, 200b, 200c, and additional nodes 210a-d and utilizing any combination of computing and memory components located on hosts 200a, 200b, 200c, and/or additional nodes 210a-d.

If additional nodes 210a-d are near memory compute (NMC) nodes they can include their own computing components 211a-d, memory bandwidth 212a-d, and memory store and load 213a-d. If additional nodes 210a-d are memory expander nodes, to reduce complexity and costs, they can exclude local computing components 211a-d and only provide memory components 211a-d, 212a-d. Additional nodes 210a-d can use computing components 211a-d to perform operations utilizing data stored on their respective local memory components 212a-d, memory components 212a-d located other additional nodes 210a-d, memory components located on host nodes 200a, 200b, 200c, or any other memory component or data storage location incorporated in or connected to the system. Memory components 212a-d of additional nodes 210a-d can be used to read data, write data, or otherwise be used in computing tasks originating from and/or executed by local computing components 211a-d, computing components 211a-d located on other additional nodes 210a-d, computing components 201 of host nodes 200a, 200b, 200c, or other sources of computing instructions incorporated in or connected to the system.

The chain of additional nodes 210a-d is connected to at least one of host nodes 200a, 200b, 200c using interfaces 205. The chain of additional nodes 210a-d may be connected directly, by any of its component nodes to any number of host nodes 200a, 200b, 200c or indirectly through connections between host nodes 200a, 200b, 200c. FIG. 2A shows multiple sets of the chain of additional nodes 210a-d, which provides a visual representation how each host node 200a, 200b, 200c can view and interact, through interfaces 205, with a shared chain of additional nodes 210a-d independently of or in coordination with the other host nodes 200a, 200b, 200c. Furthermore, host nodes 200a, 200b, 200c do not need to differentiate between additional nodes 210a-d and their compute 211a-d and/or memory components 212a-d, 213a-d but can treat them as a unitary source of additional compute and/or memory accessible through interfaces 205.

FIG. 2B is a block diagram of a set of host nodes 200a, 200b connected to a chain of additional nodes 210a-e of an example embodiment of the invention. Host nodes 200a, 200b include computing components 201a, 201, such as but not limited to CPUs and or GPUs and memory components 202a, 202b, 202a, 202b, such as but not limited to DRAM and components necessary to access and utilize data stored on DRAM or other data storage devices. Host nodes 200a, 200b are connected using interface 205a which may be a PCIe port utilizing CXL or equivalent interface capable of direct memory access (DMA) and/or host to host connections. Host nodes are connected using interfaces 205b, 205c to a chain of additional nodes 210a-e. Interfaces 205b, 205c may be PCIe ports that utilize CXL or equivalent interfaces capable of direct memory access (DMA) and/or node to node connections.

Referring to additional node 210a as an example, the additional nodes 210a-e may include computing components 211a and memory components, such as memory bandwidth 212a and memory store and load 212b, that make available supplemental compute and/or memory to host nodes 200a, 200b. The memory components, computing components, and number of additional nodes 210a-e may be selected to provide a specific amount of memory and compute corresponding to the needs of hosts 200a, 200b. Additional nodes 210a-e are connected in a daisy chain topology with peer-to-peer interfaces 215a-d. Additional nodes 210a-e may include multiple peer-to-peer interfaces 215a-d to allow for additional nodes 210a-e to be connected in any desired topology or structure. Interfaces 215a-d may be PCIe ports that utilize CXL or equivalent interfaces capable of direct memory access (DMA) and/or peer-to-peer node connections. Interfaces 215a-d enable communication between additional nodes 210a-e and indirect communication from host nodes 200a, 200b to a particular additional node 210a-e that traverses other nodes. As a non-limiting example, host node 200a can access additional node 210b and utilize the compute and/or memory provided by its components by sending communications through interface 205b to additional node 211a which transfers the communications to additional node 211b through peer-to-peer interface 215a. If required, CXL protocols can be used to minimize latency bottlenecks caused by transport through the interfaces 205a-c, 215a-d.

While FIG. 2B shows two host nodes 200a, 200b and five additional nodes 210a-210e, it would be clear to one skilled in the art that any number of host nodes or additional nodes can be connected in a similar configuration. It should also be understood that by one skilled in the art that additional interfaces could be added to additional nodes 210a-e to enable the connection of more chains of additional nodes. Additional nodes 210a-e may be located on separate chips, boards, devices, or components than host nodes 201a, 201b and may be removably coupled thereto using interfaces 205b, 205c. This modular ability enables the addition, modification, or removal of the additional compute and/or memory provided by additional nodes 210a-e based on the variable needs of hosts nodes 200a, 200b or other host devices or components.

Chain of additional nodes 210a-e can be designed and constructed to fit the specific needs of host nodes 200a, 200b or other host devices or components it may be connected to. Chain of additional nodes 210a-e can also be constructed to provide the needs for specific computer implemented applications and tools, such as generative AI and machine learning, utilized by host nodes 200a, 200b that require large amounts of compute and memory. Each node 210a-e can be a near memory compute (NMC) that provides additional compute or a memory expander that provides additional memory. The specific internal components of nodes 210a-e, e.g. if it contains computing components 211a, memory components 212a, 213a, other components that supplement the functions of host nodes 200a, 200b, or any combination of the aforementioned, do not interfere with the ability to connect additional nodes 210a-e using peer-to-peer interfaces 215a-d and connect the chain of additional nodes 210a-e to host nodes through shared input output interfaces 204, b 205c. Therefore, chain of additional nodes 210a-e can be constructed or modified to be comprised of a set of nodes that provide an exact amount of additional compute, memory, or other functions to host nodes 200a, 200b. Furthermore, changing the composition of chain of additional nodes 210a-e also does not require any alteration to host nodes 200a, 200b or their local components as they can be configured to view, communicate, and interact with chain of additional nodes 210a-e as a unitary system and utilize the components of additional nodes 210a-e without distinction on which additional node 210a-e they are located on. The disclosed design can also permit disconnecting and connecting different chains of additional nodes 210a-e to hosts nodes 200a, 200b if their needs for compute and memory change. Together, the modularity, flexibility, and scalability of the disclosed design and topography of additional nodes 210a-e provide significant improvement over existing prior art designs.

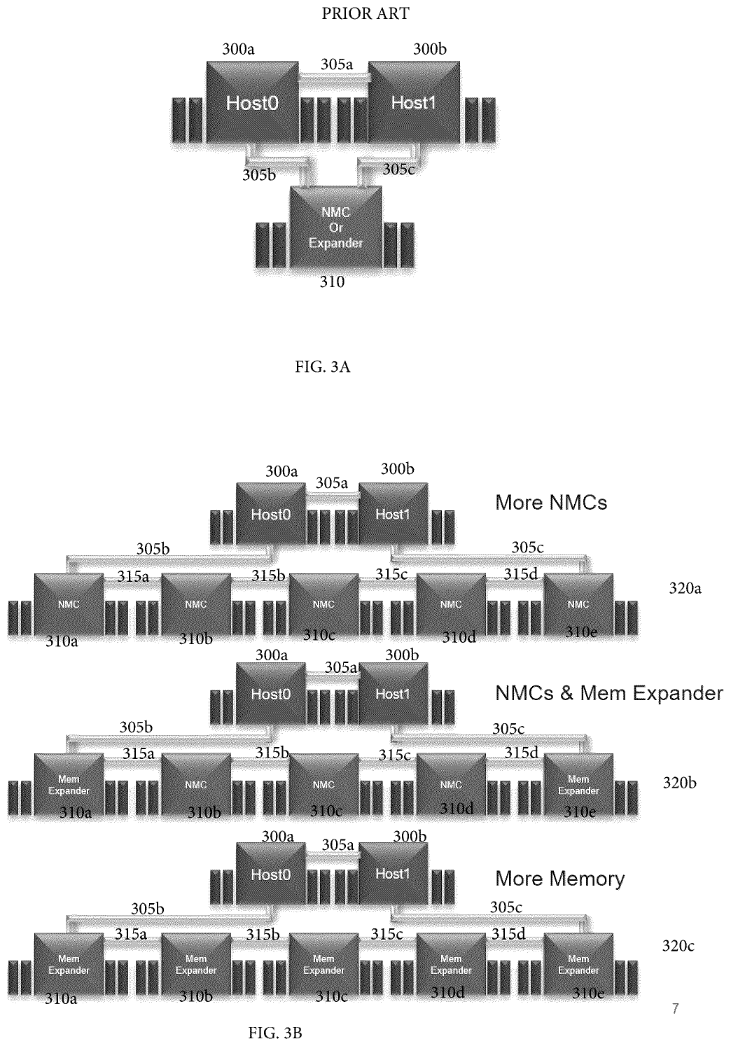

FIG. 3A is block diagram of a set of host nodes 300a, 300b connected to a near memory compute or a memory expander 310 embodying the prior art. Host nodes 300a, 300b and additional node 310 include internal components as shown by and described in relation to FIG. 1B. Host nodes 300a, 300b are connected using interface 104, 305a, and are connected to additional node 310 using input output interfaces 105a, 305b, 105b 305c. As shown in FIG. 3A, without the novel peer-to-peer capabilities disclosed herein, the system is limited to a single predetermined additional node 310 because host nodes 300a, 300b lack additional input output interfaces 305a, 305b. Therefore, even if host nodes 300a, 300b require both additional compute and memory, additional node 310 can only function as either a near memory compute (NMC) or a memory expander and therefore is incapable of satisfying the needs of host nodes 300a, 300b. Additionally, if the needs of hosts 300a, 300b change, there is no simple way to add additional compute or memory to the system or to reallocate the functionalities of additional node 310.

FIG. 3B is block diagrams of an alternative systems 320a, 320b, 320c of a set of host nodes 300a, 300b connected to near memory computes, memory expanders, or both 310a-e of example embodiments of the invention. Host nodes 300a, 300b and additional node 310a-e include internal components as shown by and described in relation to FIG. 2B. Additional nodes 310a-e may have any combination of computing components 111, memory components 112, 113, or additional components to enable them to function as a near memory compute, memory expander, or both. Host nodes 300a, 300b are connected using interface 205a, 305a, and are connected to additional node 310 using input output interfaces 205b, 305b, 205c, 305c. Additional nodes 310a-e are connected using peer-to-peer interfaces 215a-d, 315a-d. Interfaces 305a, 305b, 305c, 315a-d may be PCIe express ports that enable CXL connections. Alternatively, interfaces 305a, 305b, 305c, 315a-d can be any type of port, connection, architecture, or device that enables inter-device or inter-chip or node to node communication and utilize any compatible communications standards or protocols. In contrast to the prior art system shown in FIG. 3A, the systems 320a, 320b, 320c are adaptable and tailorable to the needs of hosts 300a, 300b. If hosts 300a, 300b, need more compute, system 320a can be utilized where additional nodes 310a-e are all NMCs. Alternatively, if hosts 300a, 300b need more memory system 320c can be utilized where additional nodes 310a-e are all memory expanders. If both memory and compute are required, system 320b can be used where additional nodes 310a-e comprise a mix of NMCs and memory expanders. The chain of additional nodes 310a-e of systems 320a, 320b, 320c can be configured to removable couple with hosts 300a, 300b using input output interfaces 305a, 305b so that as the needs of hosts 300a, 300b change they can connect and/or disconnect to systems 320a-c with different combinations of NMCs and memory expanders. Similarly, the peer-to-peer interfaces 315a-d may also be removably coupled to additional nodes 310a-e to allow for the remove, addition, or swapping of individual additional nodes 310a-e. This capability to “mix and match” NMCs and memory expanders in the chain of additional nodes 310a-e ensure that hosts 300a, 300b always have the optimal amount of additional compute and/or memory available to them while both avoiding inefficient excess compute and/or memory or the creation of bottlenecks.

Systems 320a, 320b, 320c, provide further improvements over prior art systems that limit the number of additional nodes 310a-e that can be connected to hosts 300a 300b based upon the available number of direct connections provided by input output interfaces 305b, 305c. Systems 320a, 320b, 320c are configured to allow additional nodes 310a-e to connect to each other using peer-to-peer interfaces which enables theoretically unlimited amount of either NMCs or memory expanders to be connected (through the chain of nodes' 310a-e peer-to-peer interfaces 315a-d and eventually input output interfaces 305b, 305c) to host nodes 300a, 300b. This enables systems 320a, 320b, 320c to provide scalable amounts of memory and compute to hosts 300a, 300b. Both the scalability and mix and match abilities of chain of nodes 310a-e does not require any alternations to hosts 300a, 300b as they continue to view and interact with the chain of nodes 310a-e as a single NMC and/or memory expander. Chain of nodes 310a-e may be located on separate devices or chips than hosts 300a, 300b and changing between systems 320a, 320b, 320c (or any other system with any desired combination of peer-to-peer connected NMCs or memory expanders) can be as simple as unplugging and switching connections to input output interfaces 305b, 305c.

If desired, systems 320a, 320b, 320c may use methods of hotness tracking to categorize data stored in the memory provided by the chain of nodes 310a—e.g. “hot,” “warm,” and “cold,” including assigning different regions of memory on the chain of nodes 310a-e based on proximity to hosts 300a, 300b. While increasing the number of additional nodes comprising chain of nodes 310a-e may result in additional latency, due to increasing communication length through peer-to-peer interfaces 315a-d, in many modern computing applications minimizing latency is less critical than the ability to scale compute power and memory size. In particular, the ability to enable parallel operations on hosts, 300a, 300b and additional nodes 310a-e provides a huge benefit to many modern computing technologies and applications. For example, but not limited to machine learning, generative AI, electronic design automation (EDA) tools, and predictive analytics. Physical EDA tools are incorporating AI for fine-tuning settings in placement and route tools to achieve better power, performance, and area and to assist in identifying the root causes of bugs. These EDA tools are bottlenecked by their large memory requirement and systems 320a, 320b, 320c may be used to overcome those bottlenecks by making available large chains of memory expanders to hosts 300a, 300b running the EDA tools or providing AI based assistance. Any additional latency incurred would be more than tolerable considering the benefits of being able to overcome memory (or compute) bottlenecks.

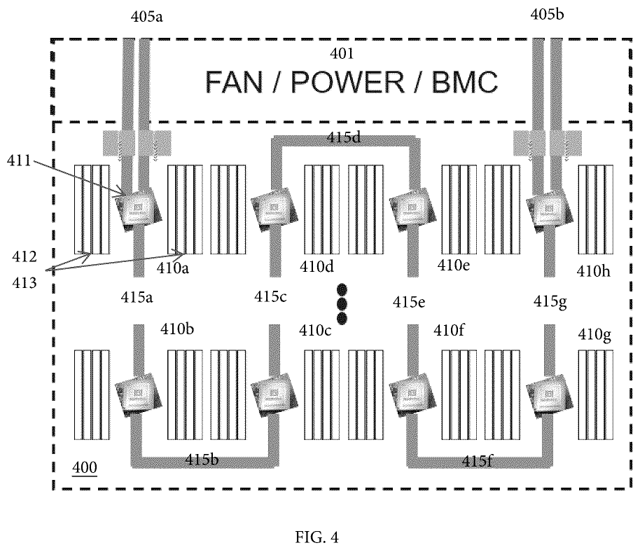

FIG. 4 is a diagram of a chip 400 that includes a set of additional nodes 411a-h capable of connecting to host nodes of an example embodiment of the invention. Chip 400 includes a set of additional nodes 411a-h connected by peer-to-peer interfaces 415a-g. Peer-to-peer interfaces 415a-g may be PCIe ports that utilize CXL. Peer-to-peer interfaces 415a-g may also be any other components capable of establishing peer-to-peer connections (both permanent and removable/reconfigurable) between additional nodes 411a-h including but not limited to components capable of direct memory access. Referring to additional node 410a as an example, additional nodes 410a-h may be comprised of computing components 411, such as CPUs, GPU, or both and memory components 412, 413 such as DRAM and/or the components to connect to and utilize DRAMs or other memory storage devices. Chip 400 may include region 401, that includes components such as, but not limited to, fans, power supplies, and/or baseboard management controllers that can be utilized by chip 400 and additional nodes 411a-h. Chip 400 includes external interfaces 405a, 405b configured to connect to host computing devices, for example through input output interfaces 205b, 205c, 305b, 305c, to enable the host computing devices to access and use the compute and/or memory provided by additional nodes 410a-h. External interfaces 405a, 405b may also be configured to connect to other chips 400 to extend the chain of additional nodes 410a-h or other computing components, chips, or devices containing more additional nodes or host nodes. Chip 400 can be located on a separate removable boards or components from host computing devices or a server containing host computing devices.

Additional nodes 410a-h can be any combination of memory expanders or NMCs required to provide the desired amount of compute and/or memory. Embodiment of chip 400 that utilize sixteen additional nodes 410, can provide access of up to 32 TB of additional memory or up to 256 ARM V2 processors provided by any desired combination of NMCs or memory expanders. In comparison, prior art designs that are incorporate on-server or on-chip solutions can only provide up to 2 TB or 16 ARM V2 processors with dedicated, non-configurable or reselectable memory expanders or NMCs.

While example embodiments have been particularly shown and described, it will be understood by those skilled in the art that various changes in form and details may be made therein without departing from the scope of the embodiments encompassed by the appended claims.

What is claimed is:

1. An apparatus comprising:
an I/O interface configured to receive at least one operation; and
a set of nodes configured to perform the received at least one operation, each node of the set of nodes comprising:
at least one peer-to-peer interface configured to connect to another node of the set of nodes and communicate the received at least one operation; and
local memory configured to store data.

2. The apparatus of claim 1 wherein at least one node of the set of nodes is a memory expander configured to provide additional memory for performing the received at least one operation.

3. The apparatus of claim 1 wherein at least one node of the set of nodes is a near memory compute (NMC) configured to provide additional compute power for performing the received at least one operation.

4. The apparatus of claim 1 wherein the set of nodes are further configured to execute the received at least one operation in parallel.

5. The apparatus of claim 1 wherein the set of nodes are connected by the peer-to-peer interfaces in a daisy chain topology.

6. The apparatus of claim 1 wherein the at least one operation originates from at least one external host.

7. The apparatus of claim 6 wherein the at least one external host utilizes the set of nodes as a unitary entity.

8. The apparatus of claim 1 wherein at least one of the I/O interface and the at least one peer-to-peer interfaces are PCI Express (PCIe) interfaces.

9. The apparatus of claim 8 wherein the PCI Express (PCIe) interfaces utilize Computer Express Link (CXL) protocol.

10. The apparatus of claim 1 wherein the set of nodes are modular and a number and a type of nodes comprising the set of nodes are variable.

11. The apparatus of claim 1 wherein the I/O interface is configured to removably couple the set of nodes to at least one host computing node.

12. The apparatus of claim 11 wherein the at least one computing node is located on a different chip than the set of nodes.

13. The apparatus of claim 1 wherein the one peer-to-peer interfaces are further configured to removably couple the set of nodes.

14. The apparatus of claim 1 wherein the set of nodes jointly execute the received at least one operation.

15. A method of performing computing operations, the method comprising:
receiving, by an I/O interface, at least on one operation; and
performing, by a set of nodes, the received at least one operation, each node of the set of nodes comprising:
at least one peer-to-peer interface configured to connect to another node of the set of nodes and communicate the received at least one operation; and
local memory configured to store data.

16. The method of claim 15 wherein at least one node of the set of nodes is a memory expander configured to provide additional memory for performing the received at least one operation.

17. The apparatus of claim 15 wherein at least one node of the set of nodes is a near memory compute (NMC) configured to provide additional compute power for performing the received at least one operation.

18. The apparatus of claim 1 wherein the set of nodes are connected by the peer-to-peer interfaces in a daisy chain topology.

19. The method of claim 1 further comprising sending, from a host computing node, the least on one operation.

20. The method of claim 19 wherein the host computing node is located on a server external to the set of nodes.

21. The method of claim 19 further comprising removably coupling the set of nodes to the host computing node utilizing the I/O interface.

22. The method of claim 19 wherein the host computing node utilizes the set of nodes as a unitary entity.

23. The method of claim 15 wherein at least one of the I/O interface and the at least one peer-to-peer interfaces are PCI Express (PCIe) interfaces.

24. The method of claim 15 further comprising modulating the number or a type of nodes comprising the set of nodes based upon the requirements of the received at least on one operation.

25. An apparatus for performing computing operations, the apparatus comprising:
means for receiving at least one operation; and
means for performing, by a set of nodes, the received at least one operation configured, each node of the set of nodes comprising means for connecting to another node of the set of nodes and communicating the received at least one operation.

26. The apparatus of claim 25 wherein the wherein at least one node of the set of nodes is a memory expander comprising means for providing additional memory for performing the received at least one operation.

27. The apparatus of claim 25 wherein at least one node of the set of nodes is a near memory compute (NMC) comprising means for providing additional compute power for performing the received at least one operation.

28. The apparatus of claim 25 further comprising means for removably coupling to a source of the at least one operation.

29. The apparatus of claim 28 wherein the source of the at least one operation utilizes the set of nodes as a unitary entity.

30. The apparatus of claim 25 further comprising means for modulating the number or a type of nodes comprising the set of nodes based upon the requirements of the received at least on one operation.
